(19) United States
(12) Patent Application Publication
(10) Pub. No.: US 2003/0076853 A1
(43) Pub. Date: Apr. 24, 2003

(54) Dual channel remote terminal

(76) Inventors: Mike Lohman, Germantown, MD (US); Jack Rozmaryn, Silver Spring, MD (US)

Correspondence Address: Hughes Electronics Corporation, Patent Docket Administration, P.O. Box 956, Bldg. 1, Mail Stop A109, El Segundo, CA, 90245-0956, US

(21) Appl. No.: 10/039,520

(22) Filed: Oct. 24, 2001

(51) Int. Cl. H04J 3/26

(52) U.S. Cl. 370/432; 370/338

(57) ABSTRACT

A terminal apparatus for providing wireless point-to-multipoint communications is disclosed. The apparatus includes a plurality of outdoor units that are configured to support simultaneously a plurality of channels. Additionally, the apparatus includes an indoor unit that is coupled to the plurality of outdoor units and is configured to receive a signal from a hub terminal over a wireless link.

### FIELD OF THE INVENTION

The present invention relates to a radio communications system, and more particularly to providing point-to-multipoint communication.

### BACKGROUND OF THE INVENTION

Wireless communications systems provide a convenient approach to deploying a voice and data infrastructure. With the advances in signal processing and communications technologies, the bandwidth and performance of such wireless systems rival that of terrestrial networks. Because wireless systems can be rapidly and cost-effectively deployed, such systems have enabled service providers to enter the broadband access market with minimal capital investment. However, issues of system availability and scalability of wireless systems have not previously been addressed satisfactorily.

Conventional wireless systems, such as point-to-multipoint (PMP) networks, have a number of drawbacks that impede their competitiveness with equivalent terrestrial solutions. One drawback is that wireless systems have a limited transmission range; that is, a radio terminal can only broadcast so far before the signal is loss due to attenuation. Given the fact that many wireless systems, in particular, PMP deployments, utilize line of sight (LOS) transmissions, physical obstacles impose a severe constraint on the range that a terminal can support. Another drawback concerns the terminal itself; in the conventional deployment, the terminal acts as a single point of failure. Related to this notion of single point of failure is the fact that traditionally, the topology of the wireless networks does not support easily rerouting traffic. Such inflexibility in the topology constitutes another drawback with the conventional design. Furthermore, traditional implementations of wireless systems do not scale well. In other words, the additional of new subscribers cannot be performed effectively, if at all without substantial costs.

Therefore, there is a need for a radio terminal that supports a flexible, scalable wireless system. There is also a need to avoid a single point of failure.

### SUMMARY OF THE INVENTION

These and other needs are addressed by the present invention, which provides a radio terminal that supports simultaneously multiple channels via multiple outdoor units. According to one embodiment of the present invention, a dual channel terminal extends coverage of a wireless network by behaving as a repeater for the signal transmissions. The dual terminal possesses two outdoor units and can be configured to operate in a load sharing mode or a test-mode. The present invention advantageously increases system availability and enhances scalability.

According to one aspect of the present invention, a system for providing wireless point-to-multipoint communications is disclosed. The system includes a first terminal that is configured to transmit a signal over a wireless link. The system also includes a second terminal that configured to receive the signal over the wireless link and to support simultaneously a plurality of channels.

According to another aspect of the present invention, a terminal apparatus for providing wireless point-to-multipoint communications is disclosed. The apparatus includes a plurality of outdoor units that are configured to support simultaneously a plurality of channels. Additionally, the apparatus includes an indoor unit that is coupled to the plurality of outdoor units and is configured to receive a signal from a hub terminal over a wireless link.

According to another aspect of the present invention, a method for providing wireless point-to-multipoint communications is disclosed. The method includes simultaneously receiving a signal over a communications channel among a plurality of communications channels supported by a single terminal. The method also includes selectively repeating the signal to another terminal.

According to another aspect of the present invention, a radio network for providing point-to-multipoint communications is disclosed. The network includes a hub node that is configured to transmit radio signals according to a first modulation scheme. The network also includes a plurality of relay nodes configured to receive the signals from the hub node and to forward the signals according to a second modulation scheme to a plurality of radio terminals.

According to another aspect of the present invention, a terminal apparatus for providing wireless point-to-multipoint communications is disclosed. The terminal apparatus includes transmission means for simultaneously supporting a plurality of channels. Additionally, the terminal apparatus includes an indoor unit that is coupled to the transmission means and configured to receive a signal from a hub terminal over a wireless link.

In yet another aspect of the present invention, a method is provided for reconfiguring a radio network that supports point-to-multipoint links. The method includes detecting a failed transmission of a signal. The method also includes rerouting the signal to a terminal that is configured to repeat the signal to a destination terminal, wherein the terminal is configured to support simultaneously a plurality of channels. The signal is transmitted over one of the plurality of channels.

In yet another aspect of the present invention, a computer-readable medium carrying one or more sequences of one or more instructions for reconfiguring a radio network that supports point-to-multipoint links is disclosed. The one or more sequences of one or more instructions includes instructions which, when executed by one or more processors, cause the one or more processors to perform the step of detecting a failed transmission of a signal. Another step includes rerouting the signal to a terminal that is configured to repeat the signal to a destination terminal, wherein the terminal is configured to support simultaneously a plurality of channels. The signal is transmitted over one of the plurality of channels.

Still other aspects, features, and advantages of the present invention are readily apparent from the following detailed description, simply by illustrating a number of particular embodiments and implementations, including the best mode contemplated for carrying out the present invention. The present invention is also capable of other and different embodiments, and its several details can be modified in various obvious respects, all without departing from the spirit and scope of the present invention. Accordingly, the drawing and description are to be regarded as illustrative in nature, and not as restrictive.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a diagram of a communications system that utilizes a point-to-multi-point (PMP) radio network, according to an embodiment of the present invention;

FIG. 2 is a diagram of a dual channel terminal used in the PMP radio network of FIG. 1;

FIG. 3 is a diagram of an indoor unit (IDU) of the dual channel terminal of FIG. 2;

FIG. 4 is a diagram of a remote terminal configured as a repeater, according to an embodiment of the present invention;

FIG. 5 is a diagram of a remote terminal used in conjunction with a hub terminal, according to an embodiment of the present invention;

FIG. 6 is a diagram of a remote terminal having a sectorized antenna and communicating with a hub terminal over a point-to-point channel, according to an embodiment of the present invention;

FIG. 7 is a diagram of a topology of a PMP radio network, according to an embodiment of the present invention;

FIG. 8 is a diagram of an exemplary implementation of the PMP radio network of the system of FIG. 7; and

FIG. 9 is a diagram of a computer system that can be used to implement an embodiment of the present invention.

### DESCRIPTION OF THE PREFERRED EMBODIMENT

In the following description, for the purposes of explanation, numerous specific details are set forth in order to provide a thorough understanding of the present invention. It is apparent, however, to one skilled in the art that the present invention may be practiced without these specific details or with an equivalent arrangement. In other instances, well-knownstructures and devices are shown in block diagr unnecessarily obscuring the present invention.

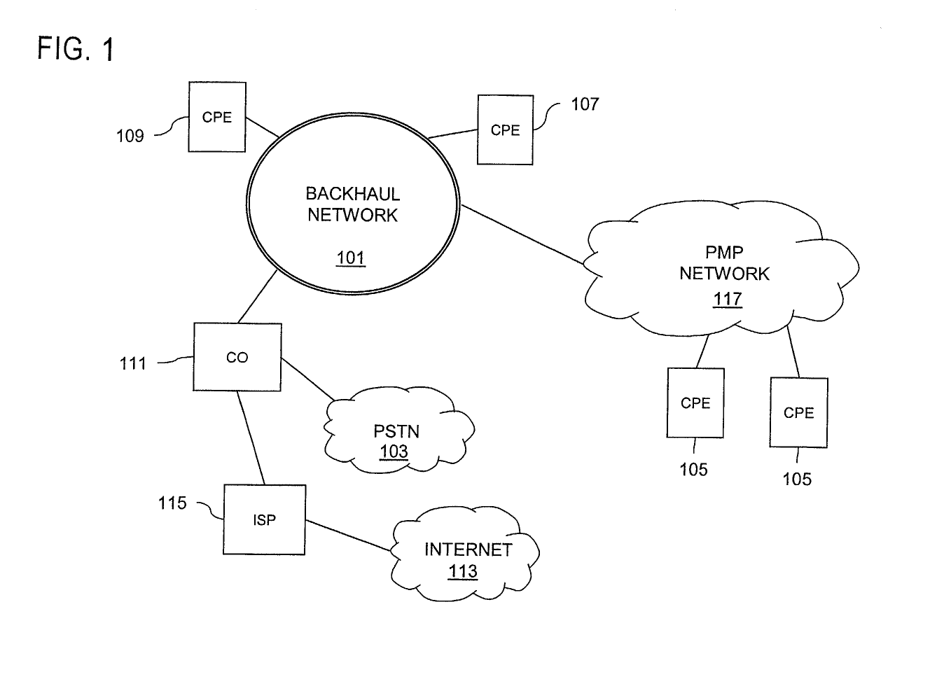

FIG. 1 shows a diagram of a communications system that utilizes a point-to-multipoint point (PMP) radio network, according to an embodiment of the present invention. A communications system 100, in an exemplary embodiment, may be deployed in a metropolitan environment in which a fiber optic network 101 carries traffic from the public switched telephone network (PSTN) 103 to a number of customer premise equipment (CPE) 105, 107, 109. A central office (CO) 111 originates traffic from the PSTN 103 as well as the Internet 113, to which the CO 111 is connected via an Internet Service Provider (ISP) 115.

In this example, the CPE 105 has connectivity to a PMP network 117. The PMP network 115, which operates in the microwave frequency range, is a wireless network that transports traffic to and from the fiber optic network 101. Within the PMP network 117 are a number of terminals that are configured as remote terminals and hub terminals.

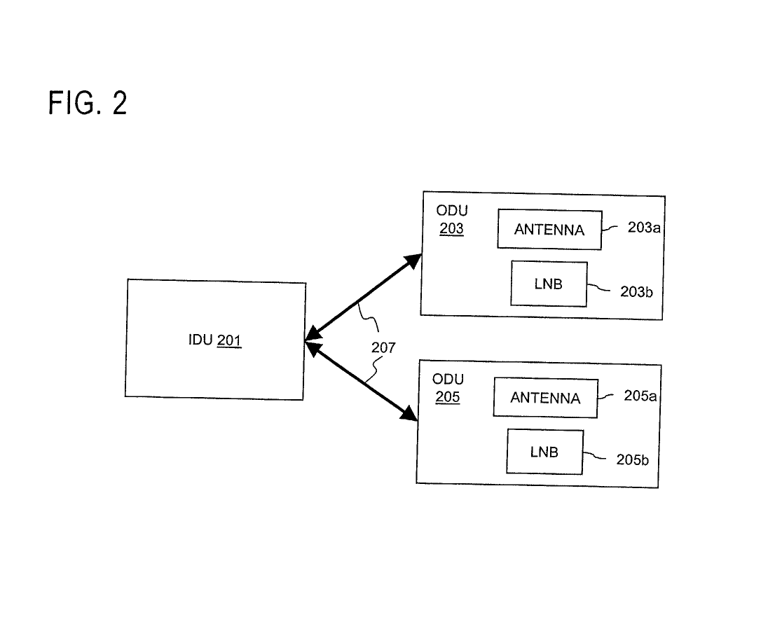

FIG. 2 shows a diagram of a dual channel terminal used in the PMP radio network of FIG. 1. In an exemplary embodiment, a terminal 200 includes an indoor unit (IDU) 201 and multiple outdoor units (ODUs) 203, 205. Each of the ODUs 203, 205 include an antenna 203a, 205a and a Low Noise Block (LNB) 203b, 205b. As will be described later, the antennas 203a, 205a may be sectorized.

Multiple ODUs 203, 205 simultaneously support multiple (in this example, two) channels and couple to the IDU 201 over IFL (inter-facilities link) cables 207, which may be optical. As used herein, the term “channel” refers to capacity (i.e., bandwidth) that is dedicated to support transmission between two terminals; depending on the capacity allocation technique, the channels, for example, may be in form of timeslots as in Time Division Multiple Access (TDMA). It is recognized that although two ODUs 203, 205 are described, in general any number of ODUs may be utilized. The use of multiple ODUs 203, 205 advantageously provides high availability to the subscriber, in that if one of the ODUs 203, 205 fails, the other ODU switches in. Since the terminal 200 is a true dual channel terminal 200, the backup ODU can be concurrently operational in a load-sharing mode, or in a test-mode.

Under this arrangement, the transmitter and receiver and all components of the ODU 203, 205 may be continually tested. Thus, if a failure occurs, it can be assured that the backup ODU will be operational. If the backup ODU is not tested, then over the life of the product, there is about a 50% probability that the backup ODU will fail. The continual testing of the backup ODU eliminates a hidden failure. In other words, if the backup ODU fails before the primary ODU, a hidden failure results, in that when the primary fails at a later time, the switchover will fail. The use of multiple ODUs 203, 205, which are essentially operational full-time, avoids a hidden failure of the backup ODU.

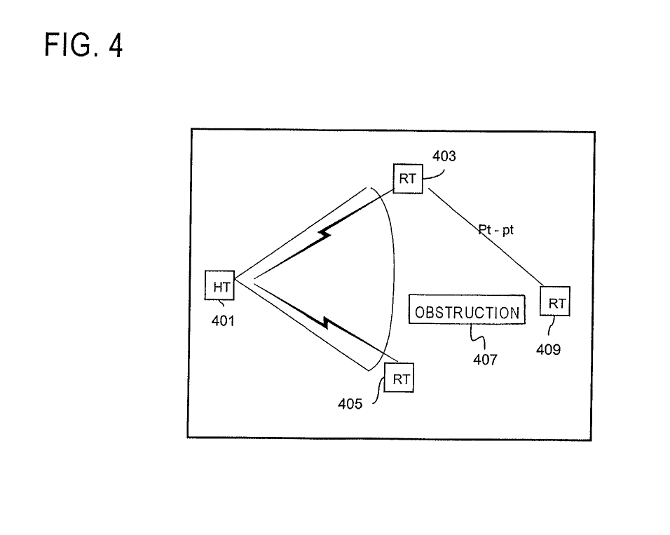

As another feature, the terminal 200 may operate as a repeater, and thereby, serve to extend the coverage area of the network. The repeater function of the terminal 200 forwards the traffic from another terminal (e.g., a hub terminal) to a destination terminal. The frequency that is used to forward the traffic can be the same or different frequency. In addition, the repeater terminal 200 can statistically multiplex the traffic from the new terminal 200. This repeater function is further described below in FIGS. 4-8.

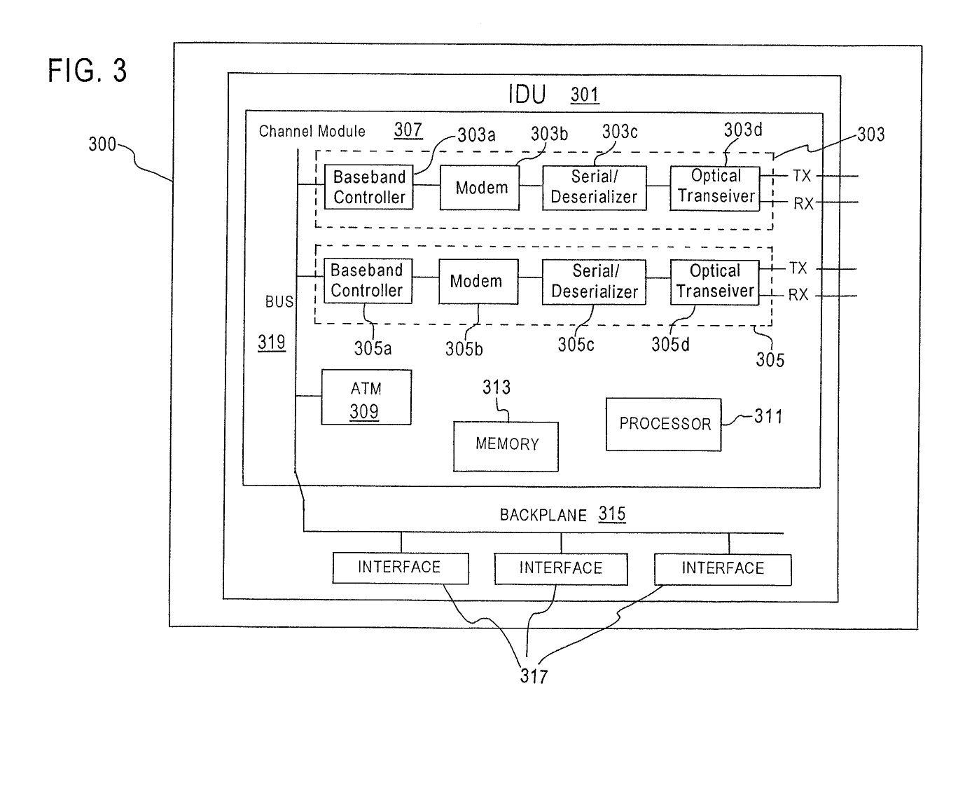

FIG. 3 shows a diagram of an indoor unit (IDU) of the dual channel terminal of FIG. 2. The Dual Channel RT block diagram is shown in FIG. 3. An IDU 301, in an exemplary embodiment, has two transceiver chains 303, 305, which are located on a channel module 307. Each of the transceiver chains 303, 305 includes a baseband controller 303a, 305a, a digital modem 303b, 305b, a serial/deserializer 303c, 305c, and an optical transceiver (i.e., transmitter/receiver) 303d, 303d. The channel module also includes common elements, such as a switching engine 309 (e.g., an Asynchronous Transfer Mode (ATM) switch, an Internet Protocol (IP) switch, an Ethernet switch, or a Virtual Local Area Network (VLAN) switch), a network and control processor 311, memory 313, and a timing recovery circuit (not shown). In addition to the channel module 307, the terminal 300 has a backplane 315 and interfaces 317; in an exemplary embodiment, three interface cards are provided.

The baseband controllers 303a, 305a interface the ATM Engine 309 via a bus 319, which is extended across the backplane 315 to the three interface cards 317. This arrangement permits traffic from the ODUs and the interface cards 317 to be statistically multiplexed, such that the traffic can be switched in any direction among all of these elements.

The ODU interface block (not shown), in an exemplary embodiment, uses a fiber optic link between the ODU and IDU, as discussed in FIG. 2. According to an embodiment of the present invention, a fiber optic interface is used because such an interface occupies a relatively small board area as compared to a non-fiber optic interface; as a result, the electronics to support multiple channels simultaneously can be packed into the space of a single channel that does not use the fiber optic interface. However, it is recognized that a non-fiber optic interface may be used, with a corresponding increase in the packaging.

One advantage of the dual channel architecture of the terminal 300 is that a mode with 1:1 redundant ODUs provides increased system availability, thereby improving service to the subscriber. Given the competitive wireless market, a key differentiator for service providers (e.g., Competitive Local Exchange Carriers) is availability. Furthermore, the dual channel terminal 300 can be deployed to extend the coverage area, as discussed below in FIG. 4.

FIG. 4 shows a diagram of a remote terminal configured as a repeater, according to an embodiment of the present invention. As noted earlier, the limitation on the range of a wireless system has hindered the deployment of such systems. The terminal of the present invention can be utilized in various wireless communications systems, such as a point-to-multipoint system (PMP) system to provide increased subscriber coverage by operating in the repeater mode, as previously discussed. The dual channel terminal, in an exemplary embodiment, may take the form of a remote terminal (RT) or a hub terminal (HT). In general, an RT resides at the customer location and communicates with the HT, which may serve one or more RTs over a wireless link. The wireless link is shared among the multiple remote terminals.

FIG. 4 shows an HT 401 that can transmit to RTs 403 and 405. An obstruction 407 exists between the HT 401 and an RT 409. This scenario reflects the landscape of many metropolitan areas, in which approximately 20-60% of the desired RT buildings is obstructed from the line-of-site to the hub location. By using an RT in a repeater mode, obstructed sites can be served. In this example, the RT 409 can still be served by the HT 401 via the RT 403, which operates as a repeater for the transmissions from the HT 401 to the RT 409. The arrangement of FIG. 4, therefore, can effectively extend the service coverage of the HT 401 to RT 409, despite the obstruction 407. The use of a dual channel terminal, as provided by the present invention, enables great flexibility in the topology.

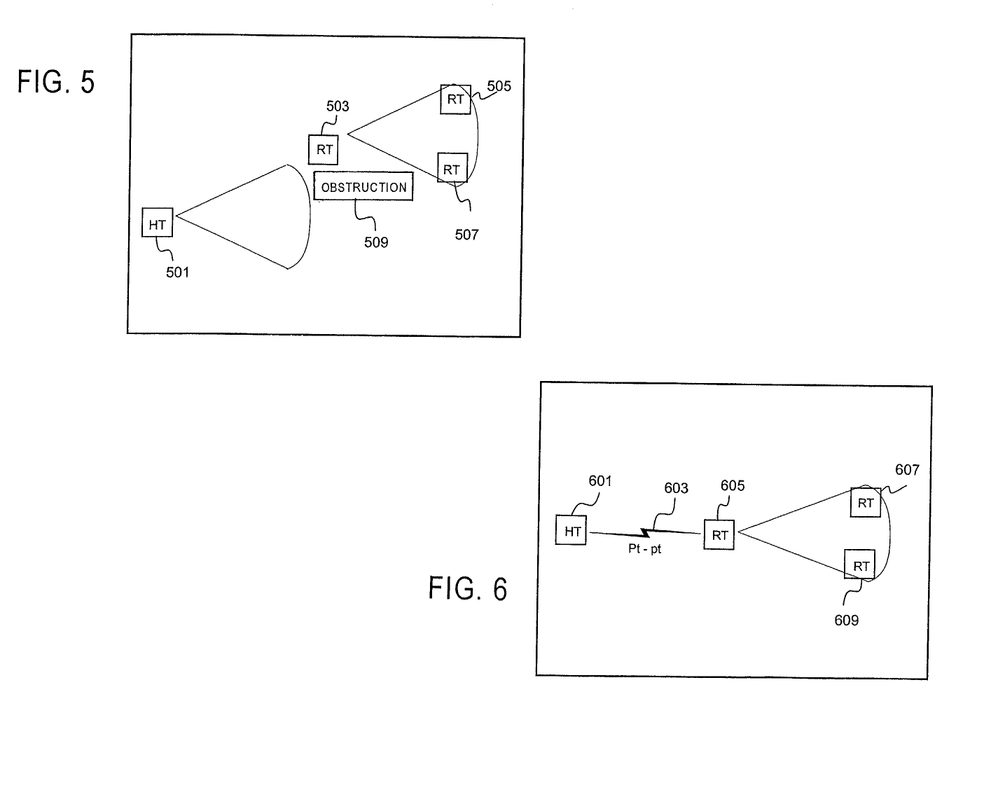

FIG. 5 shows a diagram of a remote terminal used in conjunction with a hub terminal, according to an embodiment of the present invention. Another possible use of the dual channel RT is to use the repeater function with a sectorized antenna (e.g., 90°, 45°, or 22.5°). As shown, an HT 501 broadcasts to an RT 503. The RT 503, in turn, can perform as a repeater for the transmissions from the HT 501 to RTs 505 and 507. Effectively, the repeater function of the RT 503 enables the RT 503 to behave as an HT. Consequently, the obstruction 509, which in a conventional wireless system would not allow the RTs 505, 507 to be a part of the subscriber coverage area, is circumvented.

It is noted that any number of antenna combinations, including a narrow beam antenna (e.g., 1.6°) and sectorized antennas, can be used on both ODUs.

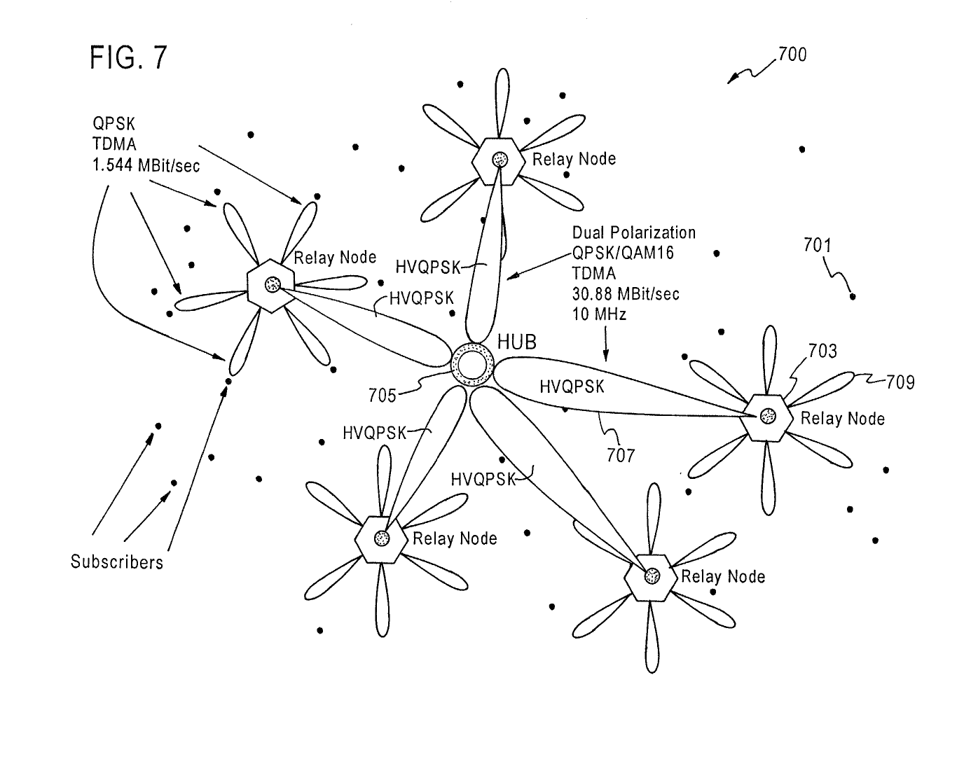

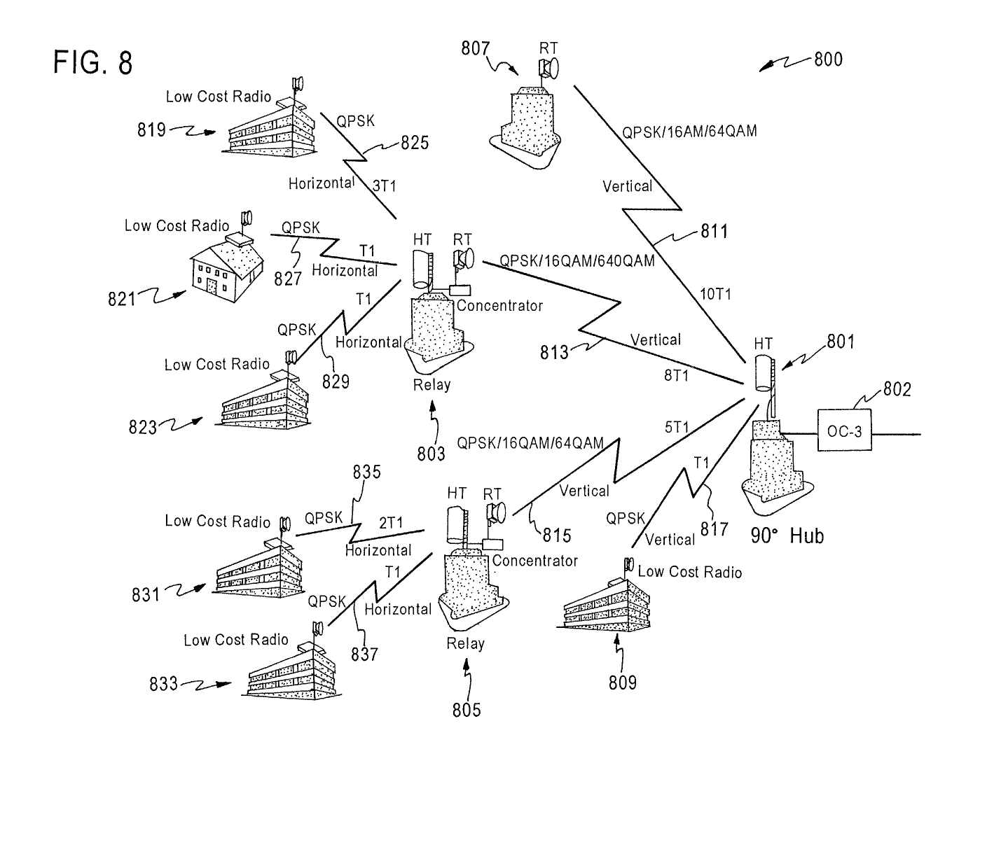

FIG. 6 shows a diagram of a remote terminal having a sectorized antenna and communicating with a hub terminal over a point-to-point channel, according to an embodiment of the present invention. In this scenario, a HT 601 communicates over a point-to-point wireless link 603 to an RT 605. The RT 605, in repeater mode, can in turn communicate with RTs 607, 609. The topologies that can be developed with the multi-channel terminal of the present invention were illustrated above with respect to FIGS. 4-6. These topologies can be used to construct a wireless system that is scalable and flexible, as next described below in FIGS. 7 and 8.

FIG. 7 shows a diagram of a topology of a PMP radio network, according to an embodiment of the present invention. A PMP radio network 700, in an exemplary embodiment, possesses a hierarchical star topology to serve numerous subscribers 701. Multiple relay nodes 703 communicate with a central hub 705 over high-speed wireless links 707; for example, these links 707 may based upon a dual polarization QPSK/QAM TDMA (Time Division Multiple Access) scheme. The QAM scheme maybe 16 or 64, depending on the characteristics of the channel. The term “relay node” refers to either a coupling between a remote terminal and a hub terminal, in which both terminal types possess multi-channel capability (as described previously), or a single remote terminal. Each of the relay nodes 703 serves the subscribers 701 that are within its coverage area over wireless links 709 that support a lower rate than that of the links 707 associated with the hub 705. In an exemplary embodiment, the wireless links 709 employ a QPSK TDMA, providing a T1 rate (1.544 Mbps); under this scheme, the channels are in form of timeslots.

The above star topology coupled with the multi-channel capability of the relay nodes 703 advantageously provides increased system availability, enhanced coverage, and promotes scalability. The system 700 scales well because of the repeater function of the relay nodes 703. Furthermore, from a network management perspective, the repeater capability of the system 700 can be utilized to enable the rerouting of traffic.

FIG. 8 shows a diagram of an exemplary implementation of the PMP radio network of the system of FIG. 7. A PMP radio network 800 employs a hub terminal 801 that has an interface 802 to a terrestrial wide area network (WAN) or local area network (LAN); the WAN and LAN are not shown. In an exemplary embodiment, the HT 801 has a 90° sectorized antenna, and the interface is an optical interface that supports an OC (Optical Carrier) −3 rate. It is recognized that any type of interface may be implemented, depending on the WAN or LAN; e.g., OC-12, T1, T3, ATM, frame relay, FDDI (Fiber Distributed Data Interface), Ethernet, and etc.

As seen in FIG. 8, the HT 801 transmits signals to relay nodes 803, 805; a remote terminal 807; and any type of low cost radio 809. The transmissions from the HT 801 to the RT 807, relay nodes 803, 805, and radio 809 are over QPSK/QAM links 811, 813, 815, 817, which support various transmission rates. For the purposes of explanation, the transmission rate is based on the T1 rate (1.544 Mbps), whereby the wireless link 811 is at T1. The link 815 is 10*T1 (15.44 Mbps), whereas the link 813 is 8*T1 (12.352 Mbps). The link 815 supports 5*T1 (7.72 Mbps).

The relay nodes 803, 805 aggregate traffic from the respective subscribers for transmission to the hub 801. Each of the relay nodes 803, 805 includes a HT and an RT, wherein the RT has responsibility for communication between the respective relay nodes 803, 805 to the hub 801, while the HT communicates with the subscribers. The relay node 803, in this example, serves three radios 819, 821, 823 over wireless links 825, 827, 829 that provide rates at 3*T1, T1, and T1, respectively. The subscriber radio 819 may require a larger bandwidth because of the applications that the particular subscriber utilizes; such a subscriber may be a medium size business, for instance. In comparison, the subscribers 821, 823 may be characteristic of a residential user and a small business. Similarly, the relay node 805 serves radios 831, 833 over a 2*T1 wireless link 835 and a T1 wireless link 837, respectively.

It is noted that the wireless system 800 employs dual polarization, in which the wireless links 811, 813, 815, 817 are associated with vertically polarized signals. The wireless links 825, 827, 829, 835, 837 use horizontally polarized signals. This arrangement advantageously minimizes signal interference.

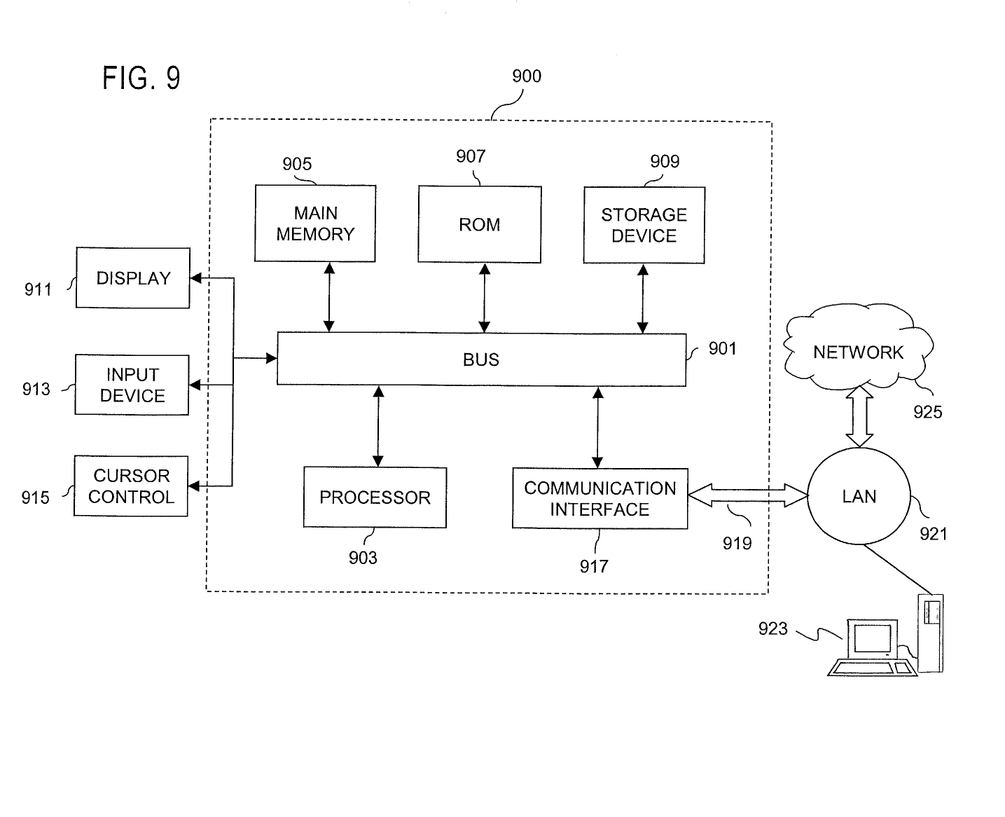

FIG. 9 illustrates a computer system 900 upon which an embodiment according to the present invention can be implemented. The computer system 900 includes a bus 901 or other communication mechanism for communicating information, and a processor 903 coupled to the bus 901 for processing information. The computer system 900 also includes main memory 905, such as a random access memory (RAM) or other dynamic storage device, coupled to the bus 901 for storing information and instructions to be executed by the processor 903. Main memory 905 can also be used for storing temporary variables or other intermediate information during execution of instructions to be executed by the processor 903. The computer system 900 further includes a read only memory (ROM) 907 or other static storage device coupled to the bus 901 for storing static information and instructions for the processor 903. A storage device 909, such as a magnetic disk or optical disk, is additionally coupled to the bus 901 for storing information and instructions.

The computer system 900 may be coupled via the bus 901 to a display 911, such as a cathode ray tube (CRT), liquid crystal display, active matrix display, or plasma display, for displaying information to a computer user. An input device 913, such as a keyboard including alphanumeric and other keys, is coupled to the bus 901 for communicating information and command selections to the processor 903. Another type of user input device is cursor control 915, such as a mouse, a trackball, or cursor direction keys for communicating direction information and command selections to the processor 903 and for controlling cursor movement on the display 911.

According to one embodiment of the invention, the switching between operational modes of the multi-channel terminal as well as the network management function is provided by the computer system 900 in response to the processor 903 executing an arrangement of instructions contained in main memory 905. Such instructions can be read into main memory 905 from another computer-readable medium, such as the storage device 909. Execution of the arrangement of instructions contained in main memory 905 causes the processor 903 to perform the process steps described herein. One or more processors in a multi-processing arrangement may also be employed to execute the instructions contained in main memory 905. In alternative embodiments, hard-wired circuitry may be used in place of or in combination with software instructions to implement the embodiment of the present invention. Thus, embodiments of the present invention are not limited to any specific combination of hardware circuitry and software.

The computer system 900 also includes a communication interface 917 coupled to bus 901. The communication interface 917 provides a two-way data communication coupling to a network link 919 connected to a local network 921. For example, the communication interface 917 may be a digital subscriber line (DSL) card or modem, an integrated services digital network (ISDN) card, a cable modem, or a telephone modem to provide a data communication connection to a corresponding type of telephone line. As another example, communication interface 917 may be a local area network (LAN) card (e.g. for Ethernet™ or an Asynchronous Transfer Model (ATM) network) to provide a data communication connection to a compatible LAN. Wireless links can also be implemented. In any such implementation, communication interface 917 sends and receives electrical, electromagnetic, or optical signals that carry digital data streams representing various types of information. Further, the communication interface 917 can include peripheral interface devices, such as a Universal Serial Bus (USB) interface, a PCMCIA (Personal Computer Memory Card International Association) interface, etc.

The network link 919 typically provides data communication through one or more networks to other data devices. For example, the network link 919 may provide a connection through local network 921 to a host computer 923, which has connectivity to a network 925 (e.g. a wide area network (WAN) or the global packet data communication network now commonly referred to as the “Internet”) or to data equipment operated by service provider. The local network 921 and network 925 both use electrical, electromagnetic, or optical signals to convey information and instructions. The signals through the various networks and the signals on network link 919 and through communication interface 917, which communicate digital data with computer system 900, are exemplary forms of carrier waves bearing the information and instructions.

The computer system 900 can send messages and receive data, including program code, through the network(s), network link 919, and communication interface 917. In the Internet example, a server (not shown) might transmit requested code belonging an application program for implementing an embodiment of the present invention through the network 925, local network 921 and communication interface 917. The processor 903 may execute the transmitted code while being received and/or store the code in storage device 99, or other non-volatile storage for later execution. In this manner, computer system 900 may obtain application code in the form of a carrier wave.

The term “computer-readable medium” as used herein refers to any medium that participates in providing instructions to the processor 903 for execution. Such a medium may take many forms, including but not limited to non-volatile media, volatile media, and transmission media. Non-volatile media include, for example, optical or magnetic disks, such as storage device 909. Volatile media include dynamic memory, such as main memory 905. Transmission media include coaxial cables, copper wire and fiber optics, including the wires that comprise bus 901. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the present invention may initially be borne on a magnetic disk of a remote computer. In such a scenario, the remote computer loads the instructions into main memory and sends the instructions over a telephone line using a modem. A modem of a local computer system receives the data on the telephone line and uses an infrared transmitter to convert the data to an infrared signal and transmit the infrared signal to a portable computing device, such as a personal digital assistance (PDA) and a laptop. An infrared detector on the portable computing device receives the information and instructions borne by the infrared signal and places the data on a bus. The bus conveys the data to main memory, from which a processor retrieves and executes the instructions. The instructions received by main memory may optionally be stored on storage device either before or after execution by processor.

Accordingly, a radio terminal simultaneously supports multiple channels via multiple outdoor units. According to one embodiment of the present invention, a dual channel terminal extends coverage of a wireless network by behaving as a repeater for the signal transmissions. The dual terminal possesses two outdoor units and can be configured to operate in a load sharing mode or a test-mode. The present invention advantageously increases system availability and enhances scalability.

While the present invention has been described in connection with a number of embodiments and implementations, the present invention is not so limited but covers various obvious modifications and equivalent arrangements, which fall within the purview of the appended claims.

What is claimed is:

1. A system for providing wireless point-to-multipoint communications, the system comprising:
a first terminal configured to transmit a signal over a wireless link; and
a second terminal configured to receive the signal over the wireless link and to support simultaneously a plurality of channels.

2. A system according to claim 1, wherein the second terminal is configured to operate in at least a first mode for supporting load sharing over the plurality of channels and a second mode to perform testing.

3. A system according to claim 1, wherein the second terminal is configured to repeat the received signal over one of the plurality of channels.

4. A system according to claim 1, wherein the second terminal comprises:
an indoor unit including,
a switching engine configured to switch data represented by the received signal, and
a transceiver configured to transmit the received signal over one of the plurality of channels; and
a plurality of outdoor units coupled to the indoor unit, each of the plurality of outdoor units including a plurality of antennas that are at least one of narrow beam antennas and sectorized antennas.

5. A system according to claim 4, wherein the second terminal further comprises:
a digital modem within at least one of the indoor unit and each of the plurality of outdoor units.

6. A system according to claim 4, wherein the second terminal further comprises:
a plurality of fiber optic links for providing the coupling between the plurality of outdoor units and the indoor unit.

7. A system according to claim 4, wherein the switching engine is at least one of an Asynchronous Transfer Mode (ATM) switch, an Internet Protocol (IP) switch, an Ethernet switch, and a Virtual Local Area Network (VLAN) switch..

8. A terminal apparatus for providing wireless point-to-multipoint communications, the terminal apparatus comprising:
a plurality of outdoor units configured to support simultaneously a plurality of channels; and
an indoor unit coupled to the plurality of outdoor units and configured to receive a signal from a hub terminal over a wireless link.

9. A terminal apparatus according to claim 8, wherein the indoor unit comprises:
a transceiver configured to receive a signal over one of the plurality of communications channels, and
a switching engine configured to switch data represented by the received signal.

10. A terminal apparatus according to claim 9, wherein the switching engine is at least one of an Asynchronous Transfer Mode (ATM) switch, an Internet Protocol (IP) switch, an Ethernet switch, and a Virtual Local Area Network (VLAN) switch..

11. A terminal apparatus according to claim 8, wherein each of the plurality of outdoor units comprises:
a plurality of antennas that are at least one of narrow beam antennas and sectorized antennas.

12. A terminal apparatus according to claim 8, wherein the plurality of outdoor units are configured to operate in at least a first mode to support load sharing over the plurality of channels and a second mode to perform testing.

13. A terminal apparatus according to claim 8, wherein the indoor unit is configured to repeat the received signal over one of the plurality of channels via a corresponding one of the plurality of outdoor units.

14. A terminal apparatus according to claim 8, wherein at least one of the indoor unit and each of the plurality of outdoor units comprises a digital modem.

15. A terminal apparatus according to claim 8, further comprising:
a plurality of fiber optic links for providing the coupling between the plurality of outdoor units and the indoor unit.

16. A method for providing wireless point-to-multipoint communications, the method comprising:
simultaneously receiving a signal over a communications channel among a plurality of communications channels supported by a single terminal; and
selectively repeating the signal to another terminal.

17. A method according to claim 16, further comprising:
operating in at least a first mode to support load sharing over the plurality of communications channels and a second mode to perform testing.

18. A method according to claim 16, further comprising:
switching data represented by the received signal using a switching engine that includes at least one of an Asynchronous Transfer Mode (ATM) switch, an Internet Protocol (IP) switch, an Ethernet switch, and a Virtual Local Area Network (VLAN) switch.

19. A method according to claim 16, further comprising:
demodulating the received signal using a predetermined modulation scheme that includes at least one of dual polarization Quadrature Phase Shift Keying (QPSK) and dual polarization Quadrature Amplitude Modulation (QAM).

20. A radio network for providing point-to-multipoint communications, the network comprising:
a hub node configured to transmit radio signals according to a first modulation scheme; and
a plurality of relay nodes configured to receive the signals from the hub node and to forward the signals according to a second modulation scheme to a plurality of radio terminals.

21. A network according to claim 20, wherein each of the relay nodes comprises a plurality of terminals.

22. A network according to claim 21, wherein one of the plurality of terminals provides simultaneous transmission over a plurality of channels.

23. A network according to claim 20, wherein the first modulation scheme includes at least one of Quadrature Phase Shift Keying (QPSK) and Quadrature Amplitude Modulation (QAM), and the second modulation scheme is dual polarization QPSK.

24. A terminal apparatus for providing wireless point-to-multipoint communications, the terminal apparatus comprising:
transmission means for simultaneously supporting a plurality of channels; and
an indoor unit coupled to the transmission means and configured to receive a signal from a hub terminal over a wireless link.

25. A terminal apparatus according to claim 24, wherein the indoor unit comprises:
a transceiver configured to receive a signal over one of the plurality of communications channels, and
a switching engine configured to switch data represented by the received signal.

26. A terminal apparatus according to claim 25, wherein the switching engine is at least one of an Asynchronous Transfer Mode (ATM) switch, an Internet Protocol (IP) switch, an Ethernet switch, and a Virtual Local Area Network (VLAN) switch..

27. A terminal apparatus according to claim 24, wherein the transmission means comprises:
a plurality of antennas, each of the plurality of antennas being at least one of a narrow beam antenna and a sectorized antenna.

28. A terminal apparatus according to claim 24, wherein the transmission means operates in at least a first mode to support load sharing over the plurality of channels and a second mode to perform testing.

29. A terminal apparatus according to claim 24, wherein the indoor unit is configured to repeat the received signal over one of the plurality of channels via the transmission means.

30. A terminal apparatus according to claim 24, wherein at least one of the indoor unit and the transmission means comprises a digital modem.

31. A terminal apparatus according to claim 24, further comprising:
a plurality of fiber optic links for providing the coupling between the transmission means and the indoor unit.

32. A method for reconfiguring a radio network that supports point-to-multipoint links, the method comprising:
detecting a failed transmission of a signal; and
rerouting the signal to a terminal that is configured to repeat the signal to a destination terminal, wherein the terminal is configured to support simultaneously a plurality of channels, the signal being transmitted over one of the plurality of channels.

33. A method according to claim 32, further comprising:
instructing the terminal to operate in at least one of a first mode for supporting load sharing over the plurality of channels and a second mode to perform testing.

34. A computer-readable medium carrying one or more sequences of one or more instructions for reconfiguring a radio network that supports point-to-multipoint links, the one or more sequences of one or more instructions including instructions which, when executed by one or more processors, cause the one or more processors to perform the steps of:
detecting a failed transmission of a signal; and
rerouting the signal to a terminal that is configured to repeat the signal to a destination terminal, wherein the terminal is configured to support simultaneously a plurality of channels, the signal being transmitted over one of the plurality of channels.

35. The computer-readable medium according to claim 34, wherein the one or more processors further perform the step of:
instructing the terminal to operate in at least one of a first mode for supporting load sharing over the plurality of channels and a second mode to perform testing.
